(19) United States
(12) Patent Application Publication
(10) Pub. No.: US 2023/0051286 A1
(43) Pub. Date: Feb. 16, 2023

(54) FLOW CONTROL INSERT FOR AN AGENT DISTRIBUTION SYSTEM

(71) Applicant: Kidde Technologies, Inc., Wilson, NC (US)

(72) Inventors: Eli Baldwin, Knightdale, NC (US); Mark P. Fazzio, Wilson, NC (US)

(21) Appl. No.: 17/399,705

(22) Filed: Aug. 11, 2021

(51) Int. Cl. F15D 1/04; F15D 1/14

(52) U.S. Cl. CPC F15D 1/04; F15D 1/14

(57) ABSTRACT

A flow control insert includes a main body that is shaped as a cylinder, is hollow, and includes an opening at a first end and at a second end, opposite the first end, along an axial length of the cylinder. An outer surface of the main body includes threading to screw into complementary threading on an inner surface of a pipe configured to flow an agent. The flow control insert also includes a diverter within the main body or extending from the first end of the main body. The diverter controls a mass split of the agent or flow energy of the agent flowing in the pipe.

### BACKGROUND

Exemplary embodiments pertain to the art of agent distribution and, in particular, to a flow control insert for an agent distribution system.

The distribution system that supplies an agent into a space can affect the concentration of the agent in different areas of the space and, consequently, the effectiveness of the agent in the space. For example, in a fire suppression system, optimal distribution of a fire suppression agent ensures a sufficient concentration of the agent in different areas. At the same time, an ideal distribution system would require a minimal total mass of the fire suppression agent.

### BRIEF DESCRIPTION

In one embodiment, a flow control insert includes a main body that is shaped as a cylinder, is hollow, and includes an opening at a first end and at a second end, opposite the first end, along an axial length of the cylinder. An outer surface of the main body includes threading to screw into complementary threading on an inner surface of a pipe configured to flow an agent. The flow control insert also includes a diverter within the main body or extending from the first end of the main body. The diverter controls a mass split of the agent or flow energy of the agent flowing in the pipe.

Additionally or alternatively, the diverter is shaped as an extension from a portion of the first end of the main body with a first diverter end contacting the portion of the first end of the main body and a second diverter end, opposite the first diverter end, and the diverter is curved such that the second diverter end is closer to a radial center of the main body than the first diverter end.

Additionally or alternatively, the main body includes a hole between the first end and the second end, and a longest portion of the hole extends over a range of axial positions along the axial length of the cylinder.

Additionally or alternatively, the diverter is within the main body, the diverter extends from an inner surface of the main body, the diverter is located opposite the hole along a radial length of the cylinder, and a center of the diverter is at a position that is within the range of axial positions along the axial length of the cylinder.

Additionally or alternatively, the diverter is shaped such that the center of the diverter is closer to a radial center of the main body than other portions of the diverter and the diverter includes a slope on both sides of the center of the diverter from the center of the diverter to the inner surface of the main body.

In another embodiment, an agent distribution system includes a network of pipes to facilitate a flow of the agent from an inlet to two or more outlets. The agent distribution system also includes a flow control insert with a main body that is shaped as a cylinder, is hollow, and includes an opening at a first end and at a second end, opposite the first end, along an axial length of the cylinder. An outer surface of the main body includes threading to screw into complementary threading on an inner surface of a pipe among the network of pipes. The flow control insert also includes a diverter within the main body or extending from the first end of the main body. The diverter controls a mass split of the agent or flow energy of the agent flowing in the pipe.

Additionally or alternatively, the diverter is shaped as an extension from a portion of the first end of the main body with a first diverter end contacting the portion of the first end of the main body and a second diverter end, opposite the first diverter end, and the diverter is curved such that the second diverter end is closer to a radial center of the main body than the first diverter end.

Additionally or alternatively, the network of pipes includes a partial-split junction at which the flow of the agent in a first pipe among the network of pipes is split between a remainder of the first pipe and a side pipe that forms an angle with the first pipe.

Additionally or alternatively, the diverter is threaded within the side pipe based on the network of pipes including the partial-split junction, and the second diverter end controllably extends into the first pipe.

Additionally or alternatively, the network of pipes includes an acute full-split junction at which the flow of the agent in a first pipe is split between a first angled pipe and a second angled pipe, a first angle between the first angled pipe and the first pipe and a second angle between the second angled pipe and the first pipe being greater than 0 degrees and less than 90 degrees.

Additionally or alternatively, the diverter is threaded within the first angled pipe based on the network of pipes including the acute full-split junction, and the second diverter end controllably extends into the acute full-split junction.

Additionally or alternatively, the main body includes a hole between the first end and the second end, a longest portion of the hole extends over a range of axial positions along the axial length of the cylinder.

Additionally or alternatively, the diverter is within the main body, the diverter extends from an inner surface of the main body, the diverter is located opposite the hole along a radial length of the cylinder, and a center of the diverter is at a position that is within the range of axial positions along the axial length of the cylinder.

Additionally or alternatively, the diverter is shaped such that the center of the diverter is closer to a radial center of the main body than other portions of the diverter and the diverter includes a slope on both sides of the center of the diverter from the center of the diverter to the inner surface of the main body.

Additionally or alternatively, the network of pipes includes an obtuse full-split junction at which the flow of the agent in a first pipe is split into a second pipe and a third pipe, a first angle between the second pipe and the first pipe and a second angle between the third pipe and the first pipe being at least 90 degrees and less than 180 degrees, the flow control insert is configured to be threaded into the inner surface of the second pipe and the third pipe, and the hole in the main body of the flow control insert facilitates the flow of the agent from the first pipe into the obtuse full-split junction.

In yet another embodiment, a method of fabricating a flow control insert, the method comprising fabricating a main body to be shaped as a cylinder, to be hollow, and to include an opening at a first end and at a second end, opposite the first end, along an axial length of the cylinder and including threading on an outer surface of the main body. The threading screws into complementary threading on an inner surface of a pipe facilitates flow of an agent. The method also includes forming a diverter within the main body or to extend from the first end of the main body. The forming the diverter includes configuring the diverter to control a mass split of the agent or flow energy of the agent flowing in the pipe.

Additionally or alternatively, the forming the diverter includes shaping the diverter as an extension from a portion of the first end of the main body with a first diverter end contacting the portion of the first end of the main body and a second diverter end, opposite the first diverter end, and curving the diverter such that the second diverter end is closer to a radial center of the main body than the first diverter end.

Additionally or alternatively, the fabricating the main body includes forming a hole between the first end and the second end, a longest portion of the hole extending over a range of axial positions along the axial length of the cylinder.

Additionally or alternatively, the forming the diverter includes locating the diverter within the main body, the diverter extending from an inner surface of the main body, locating the diverter opposite the hole along a radial length of the cylinder, and positioning a center of the diverter within the range of axial positions along the axial length of the cylinder.

Additionally or alternatively, the forming the diverter includes shaping the diverter such that the center of the diverter is closer to a radial center of the main body than other portions of the diverter and including a slope on both sides of the center of the diverter from the center of the diverter to the inner surface of the main body.

### BRIEF DESCRIPTION OF THE DRAWINGS

The following descriptions should not be considered limiting in any way. With reference to the accompanying drawings, like elements are numbered alike:

FIG. 1 is a cross-sectional view of an exemplary agent distribution system with flow control inserts according to one or more embodiments;

FIG. 2 shows a flow control insert according to one or more embodiments;

FIG. 3 is a cross-sectional view of a flow control insert within a pipe according to the exemplary embodiment shown in FIG. 2;

FIG. 4 is a cross-sectional view of the flow control insert shown in FIG. 3 in a different position;

FIG. 5 is a cross-sectional view of a flow control insert within a pipe according to the exemplary embodiment shown in FIG. 2;

FIG. 6 is a cross-sectional view of the flow control insert shown in FIG. 5 in a different position;

FIG. 7 shows a flow control insert according to one or more embodiments;

FIG. 8 is a cross-sectional view of a flow control insert within pipes according to the exemplary embodiment shown in FIG. 7; and

FIG. 9 is a cross-sectional view showing a different flow control insert according to the exemplary embodiment shown in FIG. 7.

### DETAILED DESCRIPTION

A detailed description of one or more embodiments of the disclosed apparatus and method are presented herein by way of exemplification and not limitation with reference to the Figures.

As previously noted, it is desirable for a distribution system of an agent to ensure sufficient concentration of the agent in different areas while minimizing a total mass of the agent that needs to be distributed. The network of pipes or tubing (i.e., the plumbing) of a distribution system typically includes tee and wye junctions to split the flow of the agent into multiple branches that deliver the agent to different areas. Predicting the mass split that is achieved with these junctions can be challenging, especially when the system and/or junction includes asymmetry. This challenge can be increased when dealing with a particle-based agent or a fluid agent that undergoes phase change from liquid to vapor within the network. As a result, finalizing the design of a distribution system is difficult without employing an iterative process that includes designing the network, fabricating it, conducting concentration testing on the fabrication result, and then redesigning as needed. Because such a process would be inefficient in terms of both time and cost, a base network is fabricated and adjustments to flow may be made after the fact. Prior approaches to adjustment include the use of flow splitters or diverters whose position at a junction of pipes may be adjusted according to an external screw position.

Embodiments of the systems and methods detailed herein relate to a flow control insert for an agent distribution system. A fire suppression system in an aircraft is an exemplary agent distribution system according to one or more embodiments. As detailed, one or more flow control inserts may be added at one or more junctions of the plumbing. The flow control inserts include a diverter to facilitate tuning the mass split and flow energy at the junctions. For a given distribution system in a given space, a specific set of flow control inserts may be selected (e.g., based on concentration testing of already-fabricated plumbing) and threaded or otherwise affixed within the plumbing for use. The positioning of the flow control inserts via the threading, selection of the particular flow control inserts, or both may be used to control the flow of the agent in the agent distribution system.

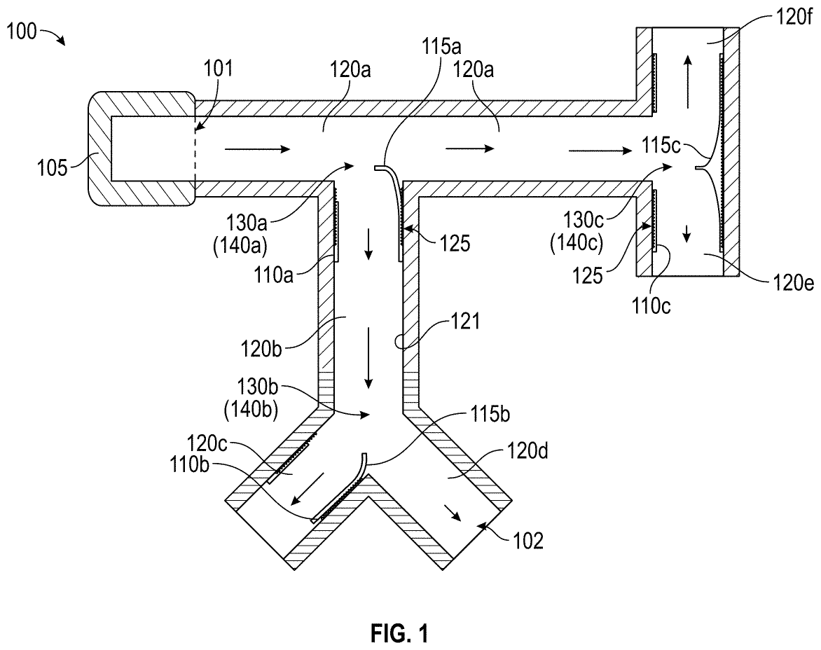

FIG. 1 is a cross-sectional view of an exemplary agent distribution system 100 with flow control inserts 110 according to one or more embodiments. The agent distribution system 110 includes an inlet 101 where the agent 105 may be input to the network of pipes 120. The agent distribution system 110 may include multiple outlets 102 from which the agent 105 is released. For example, the agent 105 may be a particle-based fire suppression agent that is distributed to the multiple outlets 102 within an aircraft or other space. The network of pipes 120 that are part of the agent distribution system 110 may include junctions 130 at which the flow of agent 105 is split. For example, a side-tee junction 130a, wye junction 130b, and bull tee junction 130c are shown. At the side-tee junction 130a, some of the flow of the agent 105 continues in the pipe 120a (following the side-tee junction 130a) and some of the flow is split to a pipe 120b that is perpendicular to the pipe 120a, as shown. At the wye junction 130b, the flow of agent 105 in the pipe 120b is split between angled pipes 120c and 120d. At the bull tee junction 130c, the flow in the pipe 120a is split into two pipes 120e, 120f that are both perpendicular to the pipe 120a and which have opposite directions for the flow of the agent 105, as shown.

While a side-tee junction 130a, wye junction 130b, and bull tee junction 130c are shown and discussed for explanatory purposes, the flow control inserts 110, according to one or more embodiments, are not limited to controlling the flow in only these particular junctions 130. More generally, the side-tee junction 130a is a partial-split junction 140a, because the pipe 120b may be at an angle other than 90 degrees relative to the pipe 120a. More generally, the wye junction 130b is an acute full-split junction 140b, because the flow in pipe 120b is completely split into pipes 120c and 120d, and each of the pipes 120c and 120d may form an angle with the pipe 120b that is greater than 0 degrees and less than 90 degrees. The angle of each of the pipes 120c and 120d relative to pipe 120b need not be the same (e.g., pipe 120c may split 30 degrees to the right relative to the flow in the pipe 120b while the pipe 120d may split 70 degrees to the left relative to the flow in the pipe 120b). In addition, the bull tee junction 130c is, more generally, an obtuse full-split junction 140c, because the flow in pipe 120a is completely split into pipes 120e and 120f, and each of the pipes 120e and 120f may form an angle with the pipe 120a that is at least 90 and less than 180 degrees. The angle of each of the pipes 120e and 120f relative to pipe 120a need not be the same (e.g., pipe 120e may split 90 degrees to the right relative to the flow in the pipe 120a, as shown, while the pipe 120f may split 110 degrees to the left relative to the flow in the pipe 120a).

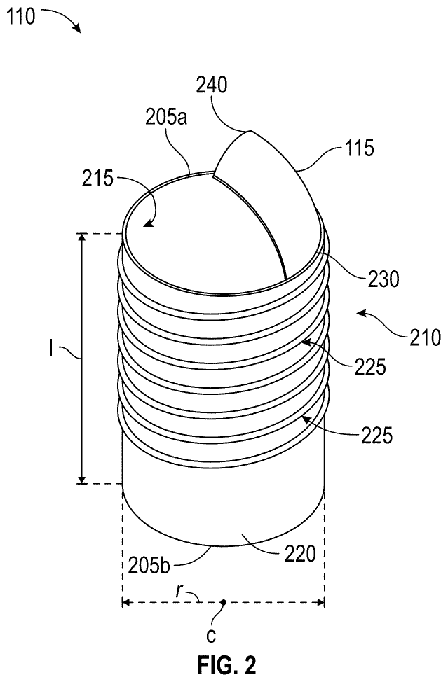

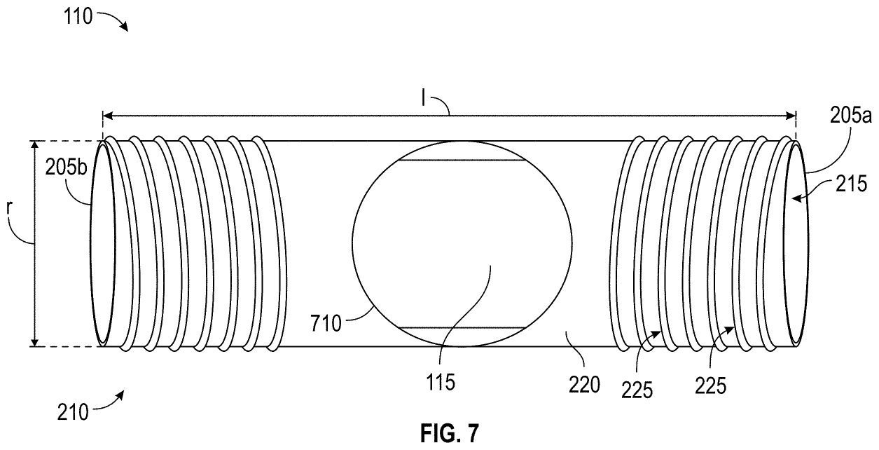

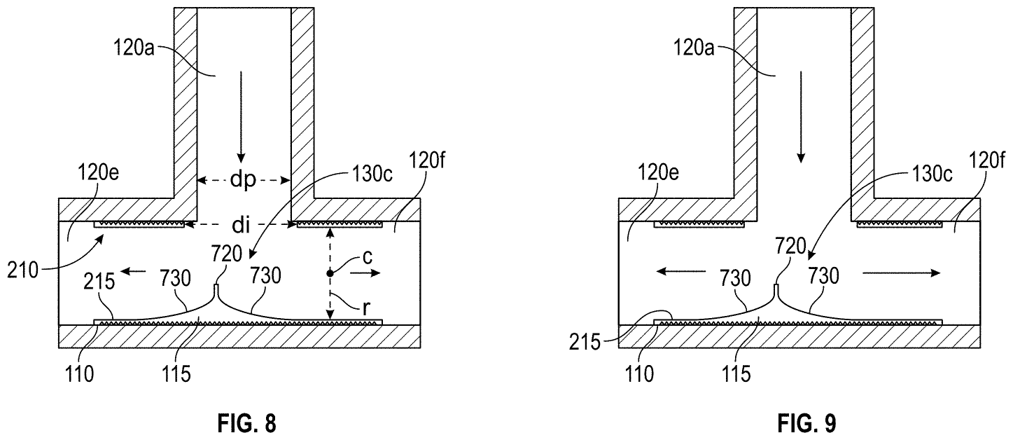

According to one or more embodiments, the flow at one or more of the junctions 140 is controlled by a flow control insert 110. Exemplary embodiments of the flow control inserts 110 are further discussed with reference to FIGS. 2-6. Generally, FIG. 1 shows that some of the pipes 120 include threading 125 at the inner surface 121. This threading is complementary to threading 225 (FIGS. 2, 7) on the outer surface 220 (FIGS. 2, 7) of the flow control inserts 110. As such, the flow control inserts 110 may be affixed within the pipes 120. The flow control inserts 110 are shown to include a diverter 115. For example, the flow control insert 110a at the side-tee junction 130a is threaded into the pipe 120b and includes a curved diverter 115a that that extends into the pipe 120a. The flow control insert 110b at the wye junction 130b is threaded into the pipe 120c and the curved diverter 115b extends into the wye junction 130b. The flow control insert 110c is threaded into both the pipes 120e, 120f that are perpendicular to the incoming pipe 120a. The diverter 115c is further discussed with reference to FIGS. 8 and 9.

At a given junction 140, a particular flow control insert 110 may be selected to control the mass split of the agent 105 and the flow energy required according to concentration testing of the network of pipes 120. That is, prior to inserting any flow control inserts 110, the concentration of agent 105 at each outlet 102 of the agent distribution system 100 may be determined. Based on this analysis, one among several options of flow control inserts 110 may be selected for inclusion at one or more junctions 130. For example, if the concentration of agent 105 at outlets 102 that are fed by pipe 120b is less than the concentration of agent 105 at outlets 102 fed by pipe 120a, then the flow control insert 110a at the side-tee junction 130a may be selected, from among available flow control inserts 110, to increase the concentration of agent 105 in pipe 120b. This selection may involve choosing a flow control insert 110 with a diverter 115 that extends further into the pipe 120a (i.e., the flow control insert 110 with the longest diverter 115 may be selected as the flow control insert 110a whose diverter 115a extends into the pipe 120a) in order to split more of the mass of the agent 105 into the pipe 120b. The curved shape of the diverter 115a facilitates maintaining flow energy of the agent 105, which would be dissipated by a straight diverter 115a.

FIG. 2 shows a flow control insert 110 according to one or more embodiments. The exemplary embodiment shows the type of flow control insert 110a, 11b indicated at the side-tee junction 130a and wye junction 130b in FIG. 1. This type of flow control insert 110a, 110b may be used at any partial-split junction 140a or acute full-split junction 140b. The diverter 115 extends from a main body 210. This main body 210 has a cylindrical shape, is hollow, and extends from one end 205a to another, opposite end 205b along the axial length 1. The radial length r is also indicated. The inner surface 215 and outer surface 220 of the main body 210 (i.e., cylinder) are indicated. The outer surface 220 includes threading 225. This threading 225 is complementary to the threading 125 at the inner surface 121 of some pipes 120, as shown in FIG. 1.

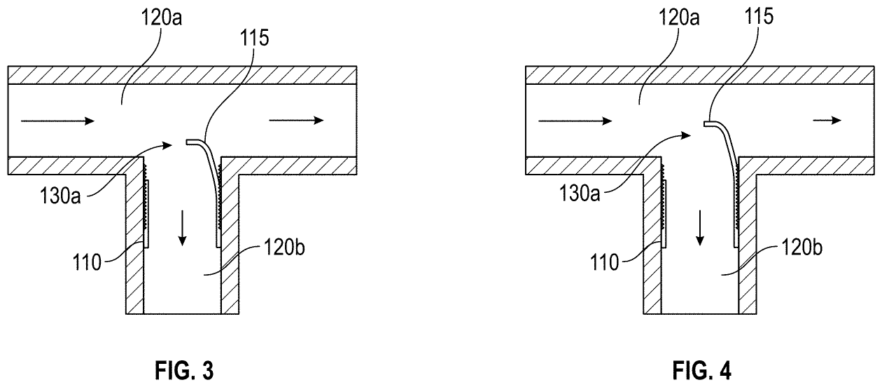

The diverter 115, according to the exemplary embodiment of the flow control insert 110 shown in FIG. 2, is a rigid extension from the main body 210 at one end 205a of the cylinder. Specifically, one end 230 of the diverter 115 is in contact with the end 205a of the main body 210 while the other end 240 of the diverter 115 extends away from the main body 210. The diverter 115 has a curved shape such that the other end 240 is closer to a radial center c of the main body 210 than the one end 230. The length of the diverter 115 (i.e., the distance between the ends 230, 240) and the curvature may be different for different flow control inserts 110. As discussed with reference to FIGS. 3-6, the particular flow control insert 110 that is selected for a particular side-tee junction 130a or wye junction 130b may be based on the length and/or curvature of the diverter 115 of available flow control inserts 110 and on results of the concentration testing on the pipes 120. Additionally or alternately, the positioning of the flow control insert 110 (e.g., how much it is threaded) may be based on results of the concentration testing.

FIG. 3 is a cross-sectional view of a flow control insert 110 within a pipe 120b according to the exemplary embodiment shown in FIG. 2. The flow control insert 110 is shown threaded into a pipe 120b at a side-tee junction 130a, with the diverter 115 extending into the pipe 120a. This is similar to the scenario discussed with reference to FIG. 1. FIG. 4 shows the same flow control insert 110 and scenario as FIG. 3. The flow control insert 110 shown in FIG. 3 is positioned (i.e., threaded) such that the diverter 115 extends into the pipe 120a less than the diverter 115 shown in FIG. 4. As a result, the flow split between the pipes 120a, 120b at the side-tee junction 130a is greater according to the positioning of the flow control insert 110 shown in FIG. 4. That is, when the flow control insert 110 is positioned such that the diverter 115 extends further into the pipe 120a, as shown in FIG. 4, more of the agent 105 is diverted or split into the pipe 120b.

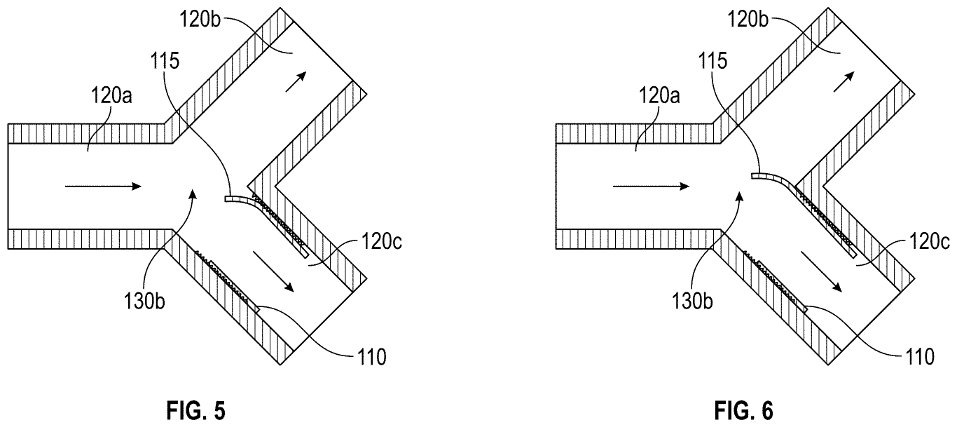

FIG. 5 is a cross-sectional view of a flow control insert 110 in a pipe 120c according to the exemplary embodiment shown in FIG. 2. The flow control insert 110 is shown threaded into a pipe 120c at a wye junction 130b, with a diverter 115 extending into the wye junction 130b. This is similar to the scenario discussed with reference to FIG. 1. FIG. 6 shows the same flow control insert 110 and scenario as FIG. 5. The flow control insert 110 shown in FIG. 5 is positioned (i.e., threaded) such that the diverter 115 extends into the wye junction 130b less than the diverter 115 shown in FIG. 6. As a result, the flow split between the pipes 120b, 120c at the wye junction 130b is greater according to the positioning of the flow control insert 110 shown in FIG. 6. That is, when the flow control insert 110 is positioned such that the diverter 115 extends further into the wye junction 130b, as shown in FIG. 6, more of the agent 105 is diverted or split into the pipe 120c.

FIG. 7 shows a flow control insert 110 according to one or more embodiments. The exemplary embodiment shows the type of flow control insert 110c indicated at the bull tee junction 130c in FIG. 1. This type of flow control insert 110c may be used at any obtuse full-split junction 140c. Based on the angle at which flow splits, the flow control insert 110c may be formed as two or more pieces that are threaded separately at the obtuse full-split junction 140c but function together. Like the exemplary embodiment shown in FIG. 2, the flow control insert 110 shown in FIG. 7 has a main body 210 that has a hollow cylindrical shape with openings at two opposite ends 205a, 205b. The outer surface 220 includes threading 225. Unlike the embodiment shown in FIG. 2, the main body 210 includes a hole 710. According to the exemplary case shown in FIG. 1, the hole would accommodate pipe 120a while the threaded portions would affix the flow control insert 110 within pipes 120e, 120f. That is, threading 225 on one side of the hole 710 may be within pipe 120e (nearer the end 205a) while threading 225 on the other side of the hole 710 (nearer the end 205b) may be within pipe 120f. The diverter 115 is within the main body 210 and is partially visible through the hole 710. This is because the diverter 115 may extend from an inner surface 215 of the main body 210 opposite the hole 710. The diverter 115 is further discussed with reference to FIGS. 8 and 9.

FIG. 8 is a cross-sectional view of a flow control insert 110 in pipes 120e, 120f according to the exemplary embodiment shown in FIG. 7. For explanatory purposes, the labels used in FIG. 1 are reused. As such, flow from a pipe 120a is split into pipes 120e, 120f at a bull tee junction 130c. As noted in the discussion of FIG. 7 and visible in FIG. 8, the flow control insert 110 has a hole 710 in the main body 210 that accommodates the pipe 120a. That is, as shown in FIG. 8, the diameter di of the hole 710 is larger than the diameter dp of the pipe 120a. The radial length r and radial center c of the main body 210 of the flow control insert 110 are indicated. As also noted in the discussion of FIG. 7, the diverter 115 is within the main body 210 of the flow control insert 110, as opposed to extending from it as in the exemplary embodiment shown in FIG. 2, and is opposite the hole 710. In this way, the diverter 710 affects the flow split into the pipes 210e, 210f at the bull tee junction 130c.

Specifically, the diverter 115 has a center 720 that extends into the main body 210, closer to the radial center c of the main body 210 than any other portion of the diverter 115. In addition, the diverter 115 includes a slope 730 on each side of the center 720 of the diverter 115. Each slope 730 is from the center 720 of the diverter 115 to the inner surface 215 of the main body 210. The center 720 of the diverter 115 affects the mass split while the slopes 730 ensure that flow energy is not dissipated. FIG. 9 shows the same scenario as FIG. 8.

However, a different flow control insert 110 is used. The flow control insert 110 shown in FIG. 9 has a diverter 115 with a center 720 that is closer to pipe 120e than pipe 120f within the bull tee junction 130c, while the flow control insert 110 shown in FIG. 8 has a diverter 115 with a center 720 that is centered within the bull tee junction 130c. As a result, the mass split in the configuration of FIG. 8 is equal between pipes 120e and 120f In the configuration of FIG. 9, more of the agent 105 would be diverted to the pipe 120f rather than to pipe 120e. As previously noted, the result of concentration testing may be the basis for using the flow control insert 110 shown in FIG. 9 versus the one shown in FIG. 8. That is, if the concentration testing indicated that outlets 102 that are fed by pipe 120f have much lower concentrations of the agent 105 than outlets 102 that are fed by pipe 120e, then the flow control insert 110 shown in FIG. 9 may be used to divert more of the flow to the pipe 120f.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A flow control insert comprising:
a main body that is shaped as a cylinder, is hollow, and includes an opening at a first end and at a second end, opposite the first end, along an axial length of the cylinder, wherein an outer surface of the main body includes threading configured to screw into complementary threading on an inner surface of a pipe configured to flow an agent; and
a diverter within the main body or extending from the first end of the main body, wherein the diverter is configured to control a mass split of the agent or flow energy of the agent flowing in the pipe.

2. The flow control insert according to claim 1, wherein the diverter is shaped as an extension from a portion of the first end of the main body with a first diverter end contacting the portion of the first end of the main body and a second diverter end, opposite the first diverter end, and the diverter is curved such that the second diverter end is closer to a radial center of the main body than the first diverter end.

3. The flow control insert according to claim 1, wherein the main body includes a hole between the first end and the second end, and a longest portion of the hole extends over a range of axial positions along the axial length of the cylinder.

4. The flow control insert according to claim 3, wherein the diverter is within the main body, the diverter extends from an inner surface of the main body, the diverter is located opposite the hole along a radial length of the cylinder, and a center of the diverter is at a position that is within the range of axial positions along the axial length of the cylinder.

5. The flow control insert according to claim 4, wherein the diverter is shaped such that the center of the diverter is closer to a radial center of the main body than other portions of the diverter and the diverter includes a slope on both sides of the center of the diverter from the center of the diverter to the inner surface of the main body.

6. An agent distribution system comprising:
a network of pipes configured to facilitate a flow of the agent from an inlet to two or more outlets; and
a flow control insert comprising:
a main body that is shaped as a cylinder, is hollow, and includes an opening at a first end and at a second end, opposite the first end, along an axial length of the cylinder, wherein an outer surface of the main body includes threading configured to screw into complementary threading on an inner surface of a pipe among the network of pipes; and
a diverter within the main body or extending from the first end of the main body, wherein the diverter is configured to control a mass split of the agent or flow energy of the agent flowing in the pipe.

7. The agent distribution system according to claim 6, wherein the diverter is shaped as an extension from a portion of the first end of the main body with a first diverter end contacting the portion of the first end of the main body and a second diverter end, opposite the first diverter end, and the diverter is curved such that the second diverter end is closer to a radial center of the main body than the first diverter end.

8. The agent distribution system according to claim 7, wherein the network of pipes includes a partial-split junction at which the flow of the agent in a first pipe among the network of pipes is split between a remainder of the first pipe and a side pipe that forms an angle with the first pipe.

9. The agent distribution system according to claim 8, wherein the diverter is threaded within the side pipe based on the network of pipes including the partial-split junction, and the second diverter end controllably extends into the first pipe.

10. The agent distribution system according to claim 7, wherein the network of pipes includes an acute full-split junction at which the flow of the agent in a first pipe is split between a first angled pipe and a second angled pipe, a first angle between the first angled pipe and the first pipe and a second angle between the second angled pipe and the first pipe being greater than 0 degrees and less than 90 degrees.

11. The agent distribution system according to claim 10, wherein the diverter is threaded within the first angled pipe based on the network of pipes including the acute full-split junction, and the second diverter end controllably extends into the acute full-split junction.

12. The agent distribution system according to claim 6, wherein the main body includes a hole between the first end and the second end, a longest portion of the hole extends over a range of axial positions along the axial length of the cylinder.

13. The agent distribution system according to claim 12, wherein the diverter is within the main body, the diverter extends from an inner surface of the main body, the diverter is located opposite the hole along a radial length of the cylinder, and a center of the diverter is at a position that is within the range of axial positions along the axial length of the cylinder.

14. The agent distribution system according to claim 13, wherein the diverter is shaped such that the center of the diverter is closer to a radial center of the main body than other portions of the diverter and the diverter includes a slope on both sides of the center of the diverter from the center of the diverter to the inner surface of the main body.

15. The agent distribution system according to claim 14, wherein the network of pipes includes an obtuse full-split junction at which the flow of the agent in a first pipe is split into a second pipe and a third pipe, a first angle between the second pipe and the first pipe and a second angle between the third pipe and the first pipe being at least 90 degrees and less than 180 degrees, the flow control insert is configured to be threaded into the inner surface of the second pipe and the third pipe, and the hole in the main body of the flow control insert facilitates the flow of the agent from the first pipe into the obtuse full-split junction.

16. A method of fabricating a flow control insert, the method comprising:
fabricating a main body to be shaped as a cylinder, to be hollow, and to include an opening at a first end and at a second end, opposite the first end, along an axial length of the cylinder;
including threading on an outer surface of the main body, wherein the threading is configured to screw into complementary threading on an inner surface of a pipe configured to flow an agent; and
forming a diverter within the main body or to extend from the first end of the main body, wherein the forming the diverter includes configuring the diverter to control a mass split of the agent or flow energy of the agent flowing in the pipe.

17. The method according to claim 16, wherein the forming the diverter includes shaping the diverter as an extension from a portion of the first end of the main body with a first diverter end contacting the portion of the first end of the main body and a second diverter end, opposite the first diverter end, and curving the diverter such that the second diverter end is closer to a radial center of the main body than the first diverter end.

18. The method according to claim 16, wherein the fabricating the main body includes forming a hole between the first end and the second end, a longest portion of the hole extending over a range of axial positions along the axial length of the cylinder.

19. The method according to claim 18, wherein the forming the diverter includes locating the diverter within the main body, the diverter extending from an inner surface of the main body, locating the diverter opposite the hole along a radial length of the cylinder, and positioning a center of the diverter within the range of axial positions along the axial length of the cylinder.

20. The method according to claim 19, wherein the forming the diverter includes shaping the diverter such that the center of the diverter is closer to a radial center of the main body than other portions of the diverter and including a slope on both sides of the center of the diverter from the center of the diverter to the inner surface of the main body.
